(19) United States
(12) Patent Application Publication
(10) Pub. No.: US 2026/0252014 A1
(43) Pub. Date: Aug. 27, 2026

(54) IMAGE FORMING APPARATUS, CONTROL METHOD OF IMAGE FORMING APPARATUS, AND COMPUTER-READABLE RECORDING MEDIUM STORING CONTROL PROGRAM OF IMAGE FORMING APPARATUS

(71) Applicant: Konica Minolta, Inc., Tokyo (JP)

(72) Inventor: Shu Yabuuchi, Tokyo (JP)

(73) Assignee: Konica Minolta, Inc., Tokyo (JP)

(21) Appl. No.: 19/443,434

(22) Filed: Jan. 8, 2026

(30) Foreign Application Priority Data
Feb. 21, 2025 (JP) 2025-026771

(51) Int. Cl. G03G 15/00; G03G 15/01

(52) U.S. Cl. CPC G03G 15/5062; G03G 15/0184; G03G 2215/00042; G03G 2215/00063; G03G 2215/00067

(57) ABSTRACT

An image forming apparatus according to the present disclosure includes a hardware processor configured to analyze color information appearing in input image data and determine, based on an analysis result, color density of each color toner image to be monitored, form a print image corresponding to the input image data in a first area of a recording medium, and form a color measurement patch of each color toner image in a second area of the recording medium at the determine color density, measure color information on the color measurement patch formed on the recording medium that is sequentially printed, and sequentially correct the input image data or image formation condition for performing printing at a next time point, based on the measured color information on the color measurement patch such that density unevenness along a predetermined direction appearing in the print image is adjusted.

### CROSS REFERENCE TO RELATED APPLICATIONS

The entire disclosure of Japanese Patent Application No. 2025-26771 filed on Feb. 21, 2025 is incorporated herein by reference in its entirety.

### BACKGROUND

### Technological Field

The present disclosure relates to an image forming apparatus, a control method for an image forming apparatus, and a computer-readable recording medium storing a control program for an image forming apparatus.

### Description of Related Art

Conventionally, a color image forming apparatus (a copying machine, a printer, a facsimile, or the like) using an electrophotographic process is known. In this type of image forming apparatus, toner images of respective colors such as C, M, Y, and K formed on photosensitive drums are transferred to an intermediate transfer member, and the toner images of the four colors are superimposed on the intermediate transfer member and then transferred to a recording medium.

In such an image forming apparatus, there is a problem in that image quality of an output image (an image output to a recording medium) changes due to deterioration over time of the photosensitive drum, the developer, or the like, an environment around the apparatus (fluctuation in temperature and humidity), or the like. Specifically, a phenomenon occurs in which color information (for example, gradation, color tone, and the like) of input image data is not faithfully reproduced in an output image (also referred to as color reproducibility).

Therefore, in a conventional image forming apparatus, calibration for stably reproducing color information of input image data in an output image has been performed. In the calibration, for example, color information of the output image transferred onto the recording medium is detected by a color sensor or the like provided in the conveyance route of the recording medium, and gradation correction data is generated based on the detection result. By using such gradation correction data, the gradation correction data can be fed back to input image data and image formation condition (for example, a charging potential, a developing potential, an exposure amount, and the like) of the image forming section. See, e.g., Japanese Unexamined Patent Publication No. H11-075067.

Conventionally, in this type of image forming apparatus, test printing of a test patch is performed in advance, and calibration is performed on the basis of color information of an output image formed at that time.

However, while the inventor of the present application is developing this type of image forming apparatus, the inventor has come up with the problem that, in the calibration according to the conventional technology, since the calibration is performed before actual printing, it is not possible to correct color density deviation that occurs during printing.

In particular, density unevenness may occur in a printed image due to toner adhering to and remaining on a photoreceptor during continuous printing under a recent environment of high-speed printing. Such density unevenness appears in the form of a streak in a printed image, and becomes a factor of a reduction in image quality. Note that such density unevenness may also occur due to a temperature change or the like of each portion during continuous printing.

In addition, the color measurement patches used in the calibration according to the related art are, for example, cyan, magenta, yellow, black, and the like having predetermined color densities, and do not necessarily completely match toner images having color densities used in an actual printed material. Therefore, the color density deviation (that is, the deviation of the application amount) detected by such a method may not completely coincide with the color density deviation in the toner image of the color density applied to the actual printed material. In other words, the correction values for the input image data and the image formation condition of the image forming section applied in the calibration according to the conventional technology may be different from the correction values that should be applied in the actual print job.

### SUMMARY

The present disclosure has been made in consideration of the above-described problem. That is, objectives of the present disclosure include providing an image forming apparatus capable of suppressing density unevenness in a printed image occurring during continuous printing, a control method for the image forming apparatus, and a computer-readable recording medium storing a control program for the image forming apparatus.

The present invention to solve the above-described problem is an electrophotographic image forming apparatus capable of performing consecutive printing, and including a hardware processor configured to:
analyze color information present in input image data set in a print job and determine, based on an analysis result, color density of each color toner image to be monitored,
form, based on the print job, a print image corresponding to the input image data in a first area of a recording medium, and form a color measurement patch of each color toner image in a second area of the recording medium at the determine color density,
measure, during the print job, color information on the color measurement patch formed on the recording medium that is sequentially printed, and
sequentially correct, during the print job, the input image data or image formation condition for performing printing at a next time point, the input image data or the image formation condition being corrected based on the measured color information on the color measurement patch such that density unevenness along a predetermined direction appearing in the print image is adjusted.

Another aspect is directed to a control method for an electrophotographic image forming apparatus capable of performing consecutive printing, and including:
analyzing color information present in input image data set in a print job and determining, based on an analysis result, color density of each color toner image to be monitored,
forming, based on the print job, a print image corresponding to the input image data in a first area of a recording medium, and forming a color measurement patch of each color toner image in a second area of the recording medium at the determine color density;
measuring, during the print job, color information on the color measurement patch formed on the recording medium that is sequentially printed; and
sequentially correcting, during the print job, the input image data or image formation condition for performing printing at a next time point, the input image data or the image formation condition being corrected based on the measured color information on the color measurement patch such that density unevenness along a predetermined direction appearing in the print image is adjusted.

Another aspect is directed to a non-transitory computer-readable recording medium storing therein a control program for an electrophotographic image forming apparatus capable of performing continuous printing, wherein
the control program is configured to:
analyze color information present in input image data set in a print job and determine, based on an analysis result, color density of each color toner image to be monitored,
form, based on the print job, a print image corresponding to the input image data in a first area of a recording medium, and form a color measurement patch of each color toner image in a second area of the recording medium at the determine color density,
measure, during the print job, color information on the color measurement patch formed on the recording medium that is sequentially printed, and
sequentially correct, during the print job, the input image data or image formation condition for performing printing at a next time point, the input image data or the image formation condition being corrected based on the measured color information on the color measurement patch such that density unevenness along a predetermined direction appearing in the print image is adjusted.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically showing an overall configuration of an image forming apparatus according to an embodiment of the present invention;

FIG. 2 is a diagram illustrating a configuration of a control system of the image forming apparatus according to an embodiment of the present invention;

FIG. 3 is a diagram illustrating an example of processing by an analysis section according to an embodiment of the present invention;

FIG. 4 is a diagram which explains an example of processing by an analysis section according to an embodiment of the present invention;

FIG. 5 is a view for explaining an example of processing of a print control section according to an embodiment of the present invention;

FIG. 6 is a diagram illustrating an example of processing performed by a correction section according to an embodiment of the present invention;

FIG. 7 is a diagram for explaining an example of processing by the correction section according to an embodiment of the present invention;

FIG. 8 is a flowchart showing an example of the operation of a controller according to the embodiment of the present invention;

FIG. 9 is a diagram illustrating a modification example of the arrangement of color measurement patches;

FIG. 10 is a diagram illustrating a modification example of processing of the analysis section according to an embodiment of the present invention; and

FIG. 11 is a diagram illustrating a modification example of a configuration of the color measurement patches.

### DETAILED DESCRIPTION OF EMBODIMENTS

Hereinafter, one or more embodiments of the present invention will be described with reference to the drawings. However, the scope of the invention is not limited to the disclosed embodiments.

### Example of Configuration of Image Forming Apparatus

First, an overall configuration of the image forming apparatus (hereinafter, referred to as “image forming apparatus 1”) according to an embodiment of the present invention will be described. Note that the image forming apparatus 1 according to the present embodiment is applied to, for example, a copier, a printer, or the like.

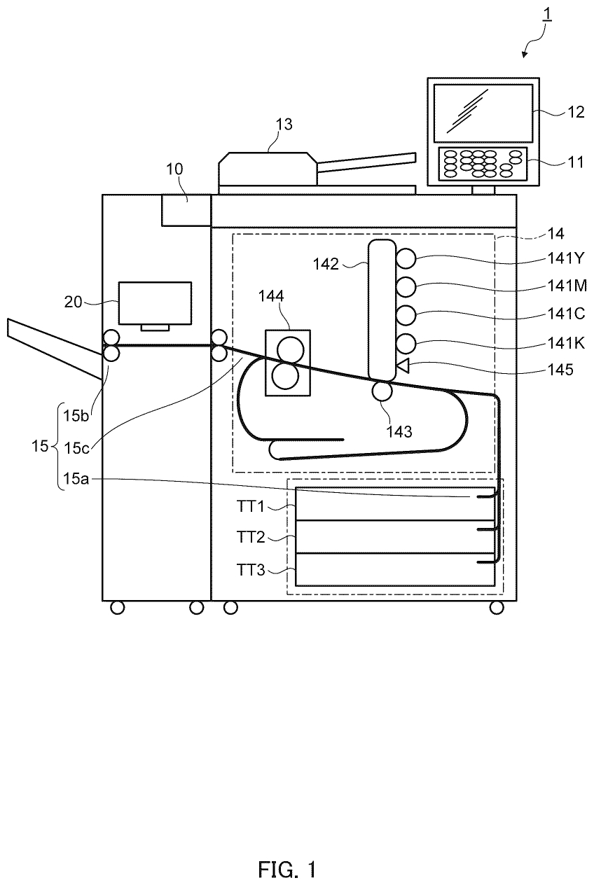

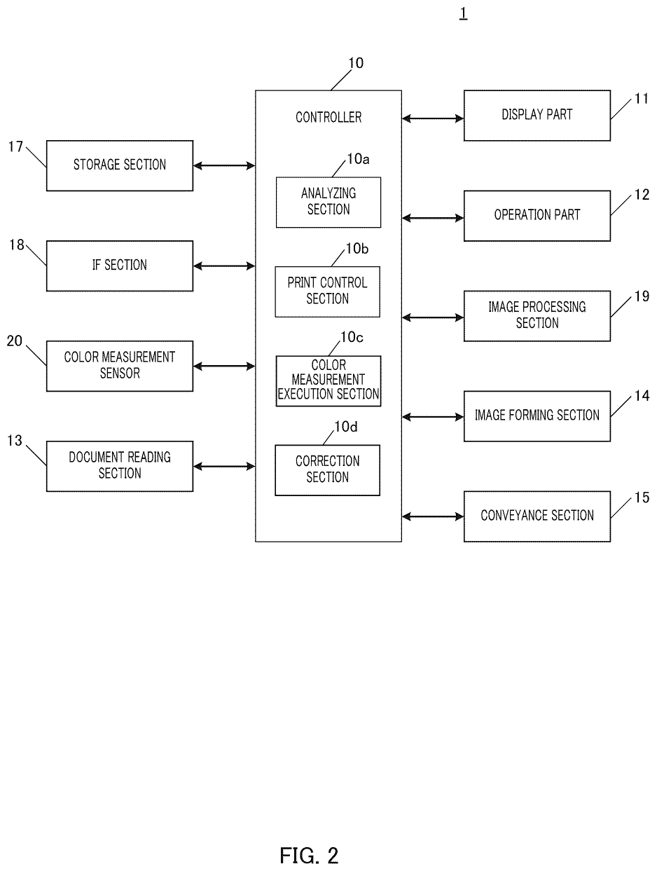

FIG. 1 is a diagram schematically illustrating an overall configuration of the image forming apparatus 1. FIG. 2 is a diagram illustrating a configuration of a control system of the image forming apparatus 1.

The image forming apparatus 1 forms a color image on a recording medium P by an electrophotographic method based on input image data obtained by reading an image from a document or input image data received from an external apparatus.

In the present embodiment, a sheet is shown as an example of the recording medium P on which image formation is performed by the image forming apparatus 1. Note however that, as recording medium P, various media can be used, including not only sheets of paper such as plain paper and coated paper, but also textiles and sheet-like resins.

The image forming apparatus 1 includes a controller 10, an operation part 11, a display part 12, a document reading section 13, an image forming section 14, a conveyance section 15, a storage section 17, an interface section 18, an image processing section 19, and a color measurement sensor 20.

The controller 10 includes a CPU, a ROM, a RAM, and the like. In the controller 10, the CPU reads a program corresponding to the processing content from the ROM, loads the program onto the RAM, and centrally controls the operation of each block of the image forming apparatus 1 in cooperation with the developed program. At this time, various data stored in the storage section 17 is referred to. The storage section 17 is constituted by, for example, a nonvolatile semiconductor memory or a hard disk drive. However, it is needless to say that each function of the controller 10 is not limited to processing by software and can be implemented by a dedicated hardware circuit.

In the present embodiment, the controller 10 functions as an analysis section 10a, a print control section 10b, a color measurement execution section 10c, and a correction section 10d of the present invention. Details of these function will be described later.

The controller 10 is configured to be able to exchange various kinds of data (e.g., input image data) with an external device (e.g., a computer) connected to a network such as a LAN or a WAN via an IF section 18.

The operation part 11 includes, for example, a touch screen and various operation buttons, and outputs an operation signal based on a user operation to the controller 10.

The display part 12 is constituted by, for example, an LCD, and displays various screens in accordance with instructions of display signals input from the controller 10.

The document reading section 13 includes, for example, an automatic document feeder (ADF), a scanner, and the like, and outputs image data obtained by reading an image of a document to the controller 10.

The image forming section 14 forms an image on the recording medium P supplied from the conveyance section 15, on the basis of the image data subjected to the image processing by the image processing section 19. The image forming section 14 includes photosensitive drums 141Y, 141M, 141C, and 141K corresponding to respective colors of yellow (Y), magenta (M), cyan (C), and black (K), an intermediate transfer belt 142, a secondary transfer roller 143, a fixing section 144, and the like.

The photosensitive drum 141Y is uniformly charged, and is then scanned and exposed to a laser beam based on the yellow image data, so that an electrostatic latent image is formed. Next, the yellow toner is adhered to the electrostatic latent image on the photosensitive drum 141Y for developing the electrostatic latent image. The photosensitive drums 141M, 141C, and 141K are the same as the photosensitive drum 141Y except that the colors to be handled are different, and thus the description thereof will be omitted.

The toner images in the respective colors formed on the photosensitive drums 141Y, 141M, 141C, and 141K are sequentially transferred onto the rotating intermediate transfer belt 142 (primary transfer). That is, a color toner image in which the toner images of four colors are superimposed is formed on the intermediate transfer belt 142. The color toner image on the intermediate transfer belt 142 is collectively transferred onto the recording medium P by the secondary transfer roller 143 (secondary transfer).

The fixing section 144 includes a heating roller that heats the recording medium P on which the color toner image has been transferred, and a pressure roller that presses the recording medium P. The fixing section 144 fixes the color toner image to the recording medium P by heating and pressing.

The conveyance section 15 includes a sheet feed section 15a, a sheet ejection section 15b, a conveyance path section 15c, and the like. In the three sheet feed trays TT1 to TT3 constituting the sheet feed section 15a, the recording medium P identified based on the basis weight, the size, and the like is accommodated for each type set in advance. The conveyance path section 15c includes a plurality of conveyance roller pairs such as registration roller pairs.

The recording medium P contained in the sheet feed trays TT1 to TT3 are fed one by one from the top and are conveyed to the image forming section 14 by the conveyance path section 15c. Then, in the image forming section 14, the toner image on the intermediate transfer belt 142 is secondarily transferred to one surface of the recording medium P at a time, and a fixing process is performed in the fixing section 144. The recording medium P carrying an image formed by image formation is ejected to the outside of the apparatus by the sheet ejection section 15b.

The storage section 17 is a nonvolatile storage device such as an HDD or a semiconductor memory that stores various types of data such as input image data.

The interface section 18 (IF section) receives input image data input from an external device.

The image processing section 19 performs necessary image processing on input image data obtained by reading an image from a document by the document reading section 13 and input image data input from an external device, and transmits the image data after the image processing to the image forming section 14. The image processing includes gradation processing, halftone processing, color conversion processing, and the like. The gradation processing is processing for converting the gradation value of each pixel of input image data into a gradation value corrected so that the density characteristic of the image formed on the recording medium P matches the target density characteristic. The halftone processing is error diffusion processing, screen processing using a systematic dither method, or the like. The color conversion processing is processing for converting each gradation value of RGB into each gradation value of CMYK.

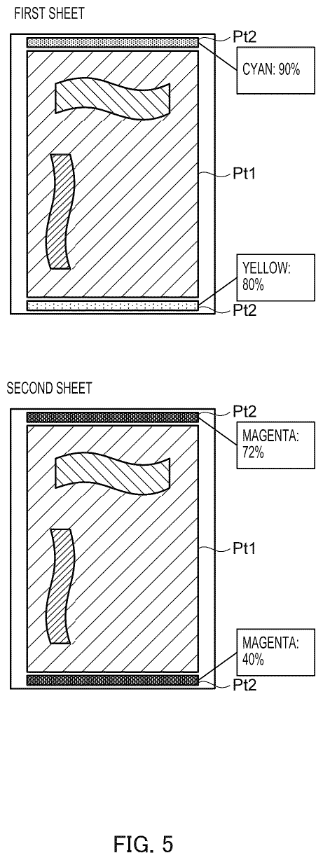

The color measurement sensor 20 is disposed on the downstream side of the image forming section 14, and performs color measurement of the color measurement patches Pt2 (see FIG. 5) formed on the recording medium P in the image forming section 14.

The color measurement sensor 20 performs color measurement of the image formed on the recording medium P by, for example, a filter method. The color measurement sensor 20 includes, for example, a light emitting element to emit light, a plurality of filters (e.g., filters of respective colors of RGB) having different spectral transmission characteristics, and a light receiving element to receive reflected light of the light via the filters.

The color measurement value obtained by the color measurement sensor 20 is, for example, expressed in the RGB color space, and the color value of each pixel area of the color measurement patch Pt2 formed on the recording medium P is expressed by the density of 256 gradations of each color of RGB.

Note that the color measurement sensor 20 may use a spectrophotometric method for color measurement instead of the filter method. In addition, the color measurement sensor 20 may include, for example, an image sensor (for example, a CCD).

Furthermore, instead of the form in which the color measurement sensor 20 outputs the color value of each pixel area as a pixel value in the RGB color space, the color measurement sensor 20 may output the color information of each pixel area as a pixel value in the Lab color space or another color space.

### Detailed Configuration of Controller 10

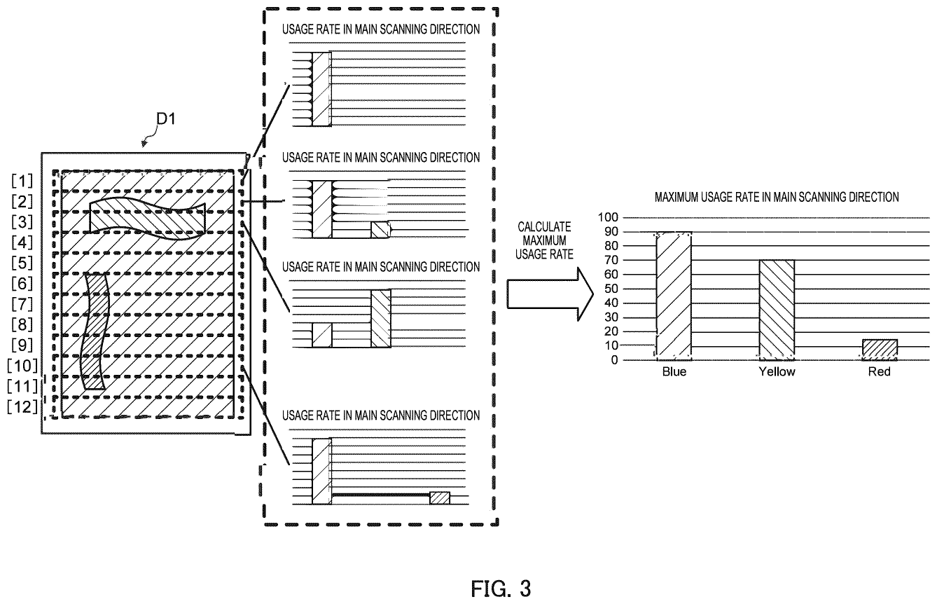

Hereinafter, a detailed configuration of the controller 10 will be described with reference to FIGS. 3 to 7.

In the present embodiment, calibration in a print job in which printing of the same image is continuously performed on different recording media P, such as advertisement printing, will be described.

As described above, in the method in which test printing of a test patch is performed in advance and calibration is performed based on color information of an output image formed at that time, as performed in a conventional image forming apparatus, it is not possible to correct density unevenness in real time during a print job.

Therefore, in the image forming apparatus 1 according to the present embodiment, the color measurement patches Pt2 are formed on the recording media P themselves which are the printed materials, and the density unevenness appearing during the continuous printing of the printed materials is detected in real time during the print job. Then, on the basis of the detection result, the input image data or the image formation condition of the image forming section 14 is sequentially corrected so as to suppress the density unevenness.

However, it is difficult to form the color measurement patch Pt2 of all gradations for each toner color by such a method. Therefore, in the image forming apparatus 1 according to the present embodiment, from the viewpoint of performing density correction with higher accuracy, color information present in input image data set in a print job is analyzed, and the color density of each color toner image to be monitored is determined based on the analysis result. Accordingly, it is possible to appropriately correct the color density deviation in the toner image of the color density applied to the actual printed material.

In the image forming apparatus 1 according to the present embodiment, the calibration is realized by the functions of the analysis section 10a, the print control section 10b, the color measurement execution section 10c, and the correction section 10d of the controller 10.

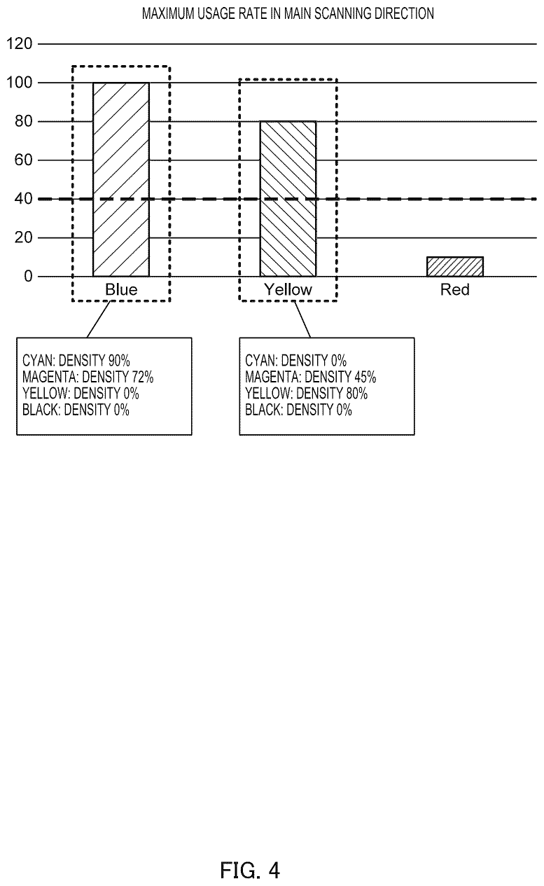

FIGS. 3 and 4 are diagrams illustrating processing of the analysis section 10a.

The analysis section 10a analyzes color information that appears in the input image date set in the print job, and determines, based on the analysis result, the color density of each color toner image to be monitored during the print job.

To be specific, first, for example, the analysis section 10a divides the input image data into a plurality of areas along the main scanning direction, and creates color frequency information that appears in each area as a histogram. Then, the analysis section 10a determines the monitoring target color from the representative colors in the histogram of each area along the main scanning direction. In this way, by determining the monitoring target color based on the color frequency information along the main scanning direction, it is possible to determine a more suitable monitoring target color for detecting the density deviation along the main scanning direction.

More specifically, at this time, for example, the analysis section 10a classifies the color of each pixel area of the input image into one of a plurality of color classes, and totals the number of pixels corresponding to each color class for each area in the main scanning direction to create a histogram. Then, the analysis section 10a collects the colors of the maximum usage rates of the respective histograms into one graph (maximum usage rate graph). Then, the analysis section 10a determines, as the monitoring target colors, representative colors having the top five highest maximum usage rates in the maximum usage rate graph and exceeding a threshold value (for example, 40% of the entire area in the main scanning direction).

Note that in FIG. 4, for convenience of explanation, only Blue, Yellow, and Red are illustrated as color classes into which the colors of the pixel areas of the input image data are classified. However, in practice, from the viewpoint of determining a more appropriate monitoring target color, it is desirable to use, as the color class, one in which each of Blue, Yellow, and Red is classified into a plurality of (e.g., 16) gradations. Further, it is desirable to treat mixed colors of the above colors as different color classes, and to use those classified into a plurality of (for example, 16) gradations.

Next, the analysis section 10a specifies the color density of each color toner image constituting the determined monitoring target color so that the density deviation (that is, the density unevenness) of the toner image of each color (here, YMCK) can be detected. The color densities of the respective color toner images forming the monitoring target colors are image formation conditions for the YMCK color measurement patches Pt2.

Note that when the monitoring target colors are expressed by gradation RGB values (R′, G′, B′) of 256 tones, the analysis section 10a specifies the color densities (Y, M, C, and K) of the toner images of the respective colors constituting the monitoring target colors, for example, using the following Expression (1) to Expression (7).

R=R′/255 Expression (1)

G=G′/255 Expression (2)

B=B′/255 Expression (3)

K=min(1−R, 1−G, 1−B) Expression (4)

C=(1−R−K)/(1−K) Equation (5)

M=(1−G−K)/(1−K) Expression (6)

Y=(1−B−K)/(1−K) Expression (7)

FIG. 4 illustrates an aspect in which Blue that is a mixed color of cyan having a density of 90% and magenta having a density of 72% and Yellow that is a mixed color of magenta having a density of 40% and yellow having a density of 80% are determined as the monitoring target colors. That is, in the case of FIG. 4, cyan having a density of 90%, magenta having a density of 72%, magenta having a density of 40%, and yellow having a density of 80% are the image formation condition of the color measurement patch Pt2 (that is, color density of each color toner image to be monitored) (see FIG. 5).

FIG. 5 is a diagram illustrating an example of a process of the print control section 10b.

The print control section 10b forms the print image Pt1 in the first area of the recording medium P based on the print job, and forms the color measurement patch Pt2 of each color toner image having the color density determined by the analysis section 10a in the second area of the recording medium P.

Here, the first area is, for example, an image forming area at the center of the recording medium P. Here, the second area is, for example, a cutting area of an end portion of the recording medium P. By forming the color measurement patches Pt2 in the cutting areas on the recording medium P, the color measurement patches Pt2 can be removed from the printed material after the actual printed material is completed. Note that the color measurement patch Pt2 may be formed in any other margin part of the recording medium P.

It is desirable that the print control section 10b forms the color measurement patch Pt2 so as to extend from one end side to the other end side of the image forming region of the recording medium P along the predetermined direction of the recording medium P. Accordingly, it is possible to detect density unevenness along the predetermined direction. The predetermined direction includes, for example, a main scanning direction. As one of the causes of the density unevenness, there is a case where the toner adheres to the photoreceptor and the density unevenness occurs along the main scanning direction of the recording medium P. However, according to the above-described configuration, it is possible to accurately detect the density unevenness.

For example, as illustrated in FIG. 5, the print control section 10b forms the color measurement patch Pt2 of each color toner image having the color density determined by the analysis section 10a in each of the cutting areas at the upstream end and the downstream end in the conveyance direction (that is, the sub-scanning direction) of the recording medium P. FIG. 5 illustrates an aspect in which the cyan color measurement patch Pt2 having a density of 90%, the magenta color measurement patch Pt2 having a density of 72%, the magenta color measurement patch Pt2 having a density of 40%, and the yellow color measurement patch Pt2 having a density of 80% are individually formed on the recording medium P. Note that the formation region of the color measurement patches Pt2 may be one of the upstream end and the downstream end of the recording medium P.

The color measurement execution section 10c is a function of measuring, using the color measurement sensor 20, color information (here, color density) of the color measurement patches Pt2 formed on the recording medium P to be sequentially printed in the image forming section 14 during the print job.

For example, when an object detection sensor (not illustrated) detects that the recording medium P has been conveyed to a position facing the color measurement sensor 20, the color measurement execution section 10c executes measurement of color information on the color measurement patches Pt2 with the color measurement sensor 20.

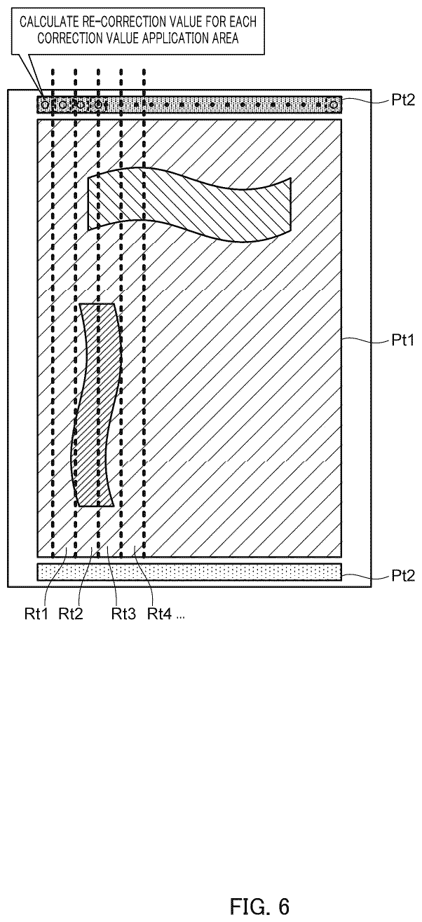

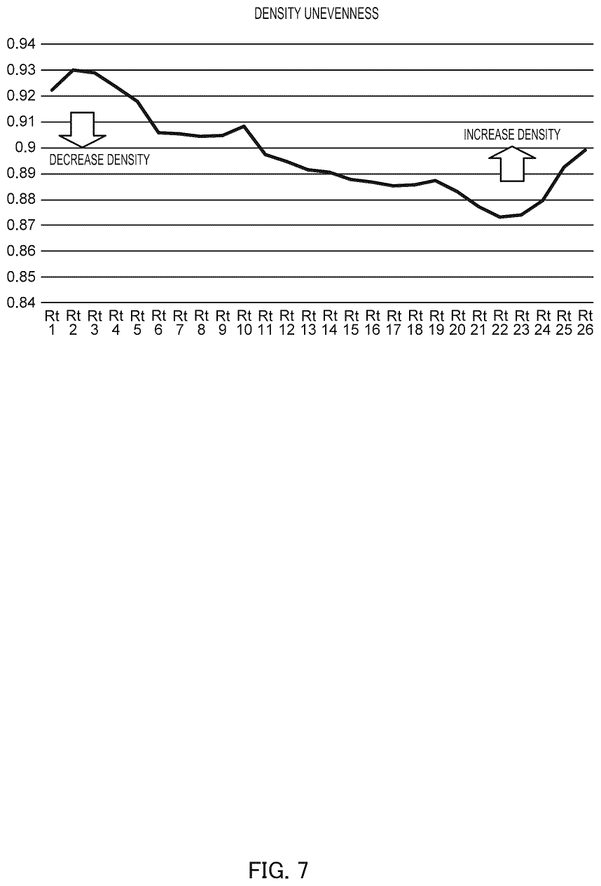

FIGS. 6 and 7 are diagrams illustrating an example of processing performed by the correction section 10d.

The correction section 10d corrects the input image data or the image formation condition of the image forming section 14 for printing performed at the next time point such that the density unevenness along the predetermined direction of the recording medium P is adjusted based on the color information on the color measurement patch Pt2 sequentially measured during the print job.

FIG. 7 shows a deviation value of the color density measured in each area along the main scanning direction of the cyan color measurement patch Pt2 in FIG. 6 from the reference value (here, the density of 90% set as the image formation condition of the cyan color measurement patch Pt2). Here, an aspect is illustrated in which the recording medium P is divided into 26 areas (Rt1, Rt2, Rt3, Rt4, and so forth in FIG. 6) along the main scanning direction.

As shown in FIG. 7, when toner adheres to the photoreceptor and density unevenness occurs along the main scanning direction of the recording medium P, the density unevenness is detected as density unevenness in the color measurement patch Pt2. In this case, the correction section 10d performs the tone correction on the recording medium P for each predetermined width area (Rt1, Rt2, Rt3, Rt4, and so forth in FIG. 6) along the main scanning direction, thereby eliminating the density unevenness appearing on the recording medium P.

In FIG. 7, the correction section 10d determines the correction value of the input image data or the image formation condition so as to fill the divergence values between the measurement values and the reference values detected in each area of the 26 areas along the main scanning direction of the color measurement patch Pt2 and adjust the density unevenness along the main scanning direction. For example, for cyan, the correction section 10d performs correction so as to decrease the density on the Rt1 area side and increase the density on the Rt26 are side.

The correction processing by the correction section 10d is the same as known tone correction processing. That is, the correction section 10d feeds back the density unevenness detected for each color of yellow (Y), magenta (M), cyan (C), and black (K) to the input image date and the image formation condition (for example, charging potential, developing potential, exposure amount, and the like) of the image forming section 14.

As shown in FIG. 5, a plurality of color measurement patches Pt2 of the same toner color may be formed (here, magenta with a density of 72% and magenta with a density of 40%). In this case, the correction section 10d may determine the correction value by, for example, taking the mean or the median between, on one hand, the divergence value between the measurement value and the reference value of one of the color measurement patches Pt2 and, on the other hand, the divergence value between the measurement value and the reference value of the other color measurement patch Pt2.

### Operation Flow of Controller

Next, an example of an operation flow of the controller 10 according to the present embodiment will be described.

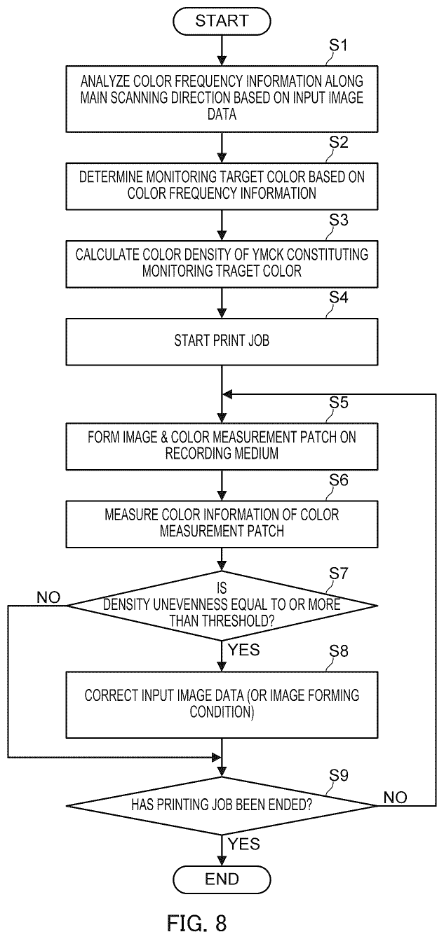

FIG. 8 is a flowchart illustrating an example of operation of the controller 10.

In step S1, the controller 10 (analysis section 10a) analyzes color frequency information along the main scanning direction. In step S1, for example, as described with reference to FIG. 3, the controller 10 derives the color frequency information of each area along the main scanning direction as a histogram.

In step S2, the controller 10 (analysis section 10a) determines a monitoring target color, based on the histogram of each area acquired in step S1. In step S2, the controller 10 extracts, for example, representative colors exceeding predetermined threshold values from the histogram of each area, and determines the representative colors as the monitoring target colors.

In step S3, the controller 10 (analysis section 10a) calculates the color density of each color toner constituting the monitoring target color. In step S3, the controller 10 calculates the color densities of the respective color toners Y, M, C, and K constituting the monitoring target color by using, for example, Expressions (1) to (7).

In step S4, the controller 10 (print control section 10b) starts a print job.

In step S5, as described with reference to FIG. 5, the controller 10 (print control section 10b) forms the print image Pt1 in the image forming region of the recording medium P based on the print job, and forms the color measurement patches Pt2 in the cutting regions of the recording medium P.

In step S6, the controller 10 (color measurement execution section 10c) measures the color information on the color measurement patches Pt2 of the recording medium P printed by the image forming section 14 using the color measurement sensor 20.

In step S7, the controller 10 (correction section 10d) determines whether or not the density unevenness is equal to or greater than the thresholds with reference to the colorimetry result of step S6. In step S7, for example, as described with reference to FIG. 7, the controller 10 determines whether or not the divergence value between the measurement value and the reference value is equal to or larger than the threshold for each of the areas of the color measurement patches Pt2 in the main scanning direction. If the divergence value between the measurement value and the reference value is greater than or equal to the threshold in any of the areas of the color measurement patches Pt2 in the main scanning direction (S7: YES), the controller 10 proceeds to step S8. On the other hand, when the divergence value between the measurement value and the reference value is less than the threshold in any of the areas of the color measurement patches Pt2 in the main scanning direction (S7: NO), the controller 10 proceeds to step S9.

In step S8, the controller 10 (correction section 10d) determines the correction value of the input image data or the image formation condition so as to fill the divergence values between the measurement values detected in the respective areas along the main scanning direction of the color measurement patches Pt2 and the reference values and adjust the gradations along the main scanning direction.

In step S9, the controller 10 determines whether or not the print job is finished. That is, here, the controller 10 determines whether or not printing of the number of sheets set in the print job has been completed. Here, when the print job has been completed (S9: YES), the controller 10 ends a series of processes of the flowchart in FIG. 8. On the other hand, when the print job is not completed (S9: NO), the controller 10 returns to step S5 and executes the print processing on the subsequent recording medium P.

Note that FIG. 8 shows a mode in which calibration (here, correction of input image data) is executed each time one copy of printed material is generated. However, the frequency of executing the calibration is appropriately changed. The controller 10 may perform the calibration at intervals of, for example, several minutes.

### Effects

As described above, the present embodiment discloses
an electrophotographic image forming apparatus capable of performing consecutive printing, and including:
an analysis section that analyzes color information present in input image data set in a print job and determines, based on the analysis result, color density of each color toner image to be monitored;
a print control section that forms, based on the print job, a print image corresponding to the input image data in a first area of a recording medium, and forms a colorimetric patch of each color toner image in a second area of the recording medium at a color density determined by the analysis section;
a color measurement section that measures, during the print job, color information on the color measurement patch formed on the recording medium that is sequentially printed; and
a correction section that sequentially corrects, during the print job, the input image data or image formation condition for performing printing at a next time point, the input image data or the image formation condition being corrected based on the measured color information on the color measurement patch such that density unevenness along a predetermined direction appearing in the print image is adjusted.

Therefore, according to the image forming apparatus of the present embodiment, it is possible to sequentially detect density unevenness that occurs during a print job and correct input image data or image formation conditions in real time so as to suppress the density unevenness.

Particularly, in the image forming apparatus according to the present embodiment, the color density of each color toner image to be monitored is determined from the color frequency information present in the input image data. During the print job, the color information on the color measurement patch corresponding to the color density of each color toner image is sequentially measured, and various corrections are performed using the measurement result as an index of the density unevenness. Therefore, it is possible to more accurately correct the density unevenness which occurs during the print job.

### Modification Example 1

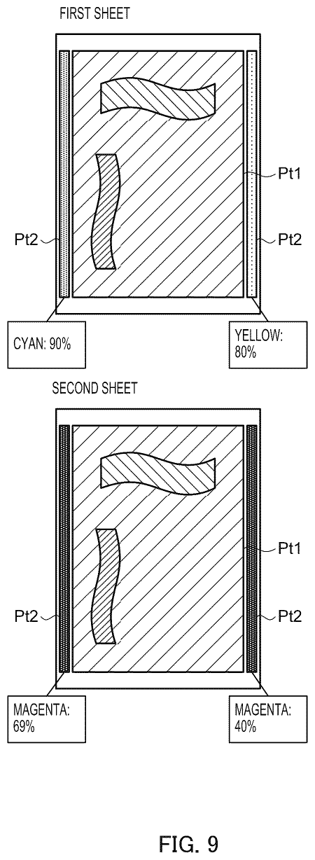

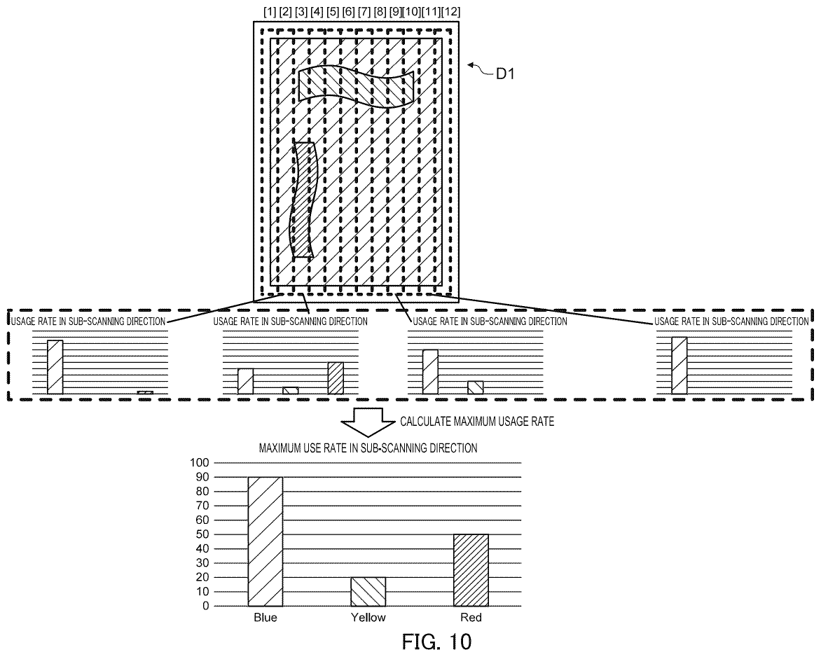

FIG. 9 is a diagram showing a modification example of the arrangement mode of the color measurement patches Pt2. FIG. 10 is a diagram illustrating a modification example of the processing of the analysis section 10a.

The color measurement patches Pt2 according to the present modification example are formed along the sub-scanning direction in the cutting regions at both ends of the recording medium P in the main scanning direction (i.e., width direction).

According to the color measurement patches Pt2 of the present modification example, it is possible to detect the density deviation along the sub-scanning direction of the recording medium P. That is, the correction section 10d according to the present modification example sets correction values for the input image date or the image formation condition so as to adjust the density deviation along the sub-scanning direction of the recording medium P. The correction value setting processing itself is as described with reference to FIG. 7.

In this case, as shown in FIG. 10, the analysis section 10a divides the input image into a plurality of areas along the sub-scanning direction, and creates color frequency information present in each area as a histogram. Then, it is desirable that the analysis section 10a determines the monitoring target color from the representative colors in the histograms of the areas along the sub-scanning direction. In this way, by determining the monitoring target color based on the color frequency information along the sub-scanning direction, it is possible to determine a more suitable monitoring target color for detecting the density deviation along the sub-scanning direction.

As described above, according to the image forming apparatus 1 of the present modification, it is possible to suppress the occurrence of density deviation along the sub-scanning direction of the recording medium P.

Note that the color measurement patches Pt2 may be formed in both the upstream and downstream areas in the conveyance direction of the recording medium P and the areas at both ends in the main scanning direction (i.e., the width direction) of the recording medium P. By doing so, it is possible to eliminate each of the density deviation along the main scanning direction of the recording medium P and the density deviation along the sub-scanning direction of the recording medium P.

### Modification Example 2

In the above-described embodiment, the controller 10 (analysis section 10a) specifies the monitoring target color based on the color frequency information, and determines the color density of each color toner image constituting the monitoring target color as the color density of each color toner image to be monitored.

However, a reference value of color density for setting a correction value may be specified in the design specifications of some image forming apparatus 1. For example, in some image forming apparatus 1, the reference value is specified as any one of 0, 6, 13, 19, 25, 31, 38, 44, 50, 56, 63, 69, 75, 81, 88, 94, and 100% obtained by dividing 256 gradation into 16 stages.

In such a case, the color density deviations from the 16-step reference values are used as correction values to be set in input image data or image formation conditions. That is, in such a case, the color density of one of the 16 reference values needs to be set as the image formation condition of the color measurement patch Pt2.

For example, FIG. 4 illustrates an aspect in which Blue that is a mixed color of cyan having a density of 90% and magenta having a density of 72% and Yellow that is a mixed color of magenta having a density of 40% and yellow having a density of 80% are determined as the monitoring target colors. In this case, the analysis section 10a sets values close to cyan having a density of 90%, magenta having a density of 72%, magenta having a density of 40%, and yellow having a density of 80% as the image formation condition for the color measurement patches Pt2.

To be specific, the analysis section 10a determines 88% and 94% as the color densities of the color measurement patches Pt2 in order to detect a state in which the density of cyan is 90%. The analysis section 10a determines 69% and 75% as the color densities of the color measurement patches Pt2 in order to detect a state in which the density of magenta is 72%. The analysis section 10a determines 38% and 44% as the color densities of the color measurement patches Pt2 in order to detect a state in which the density of magenta is 40%. The analysis section 10a determines 75% and 81% as the color densities of the color measurement patches Pt2 in order to detect a state in which the density of yellow is 80%.

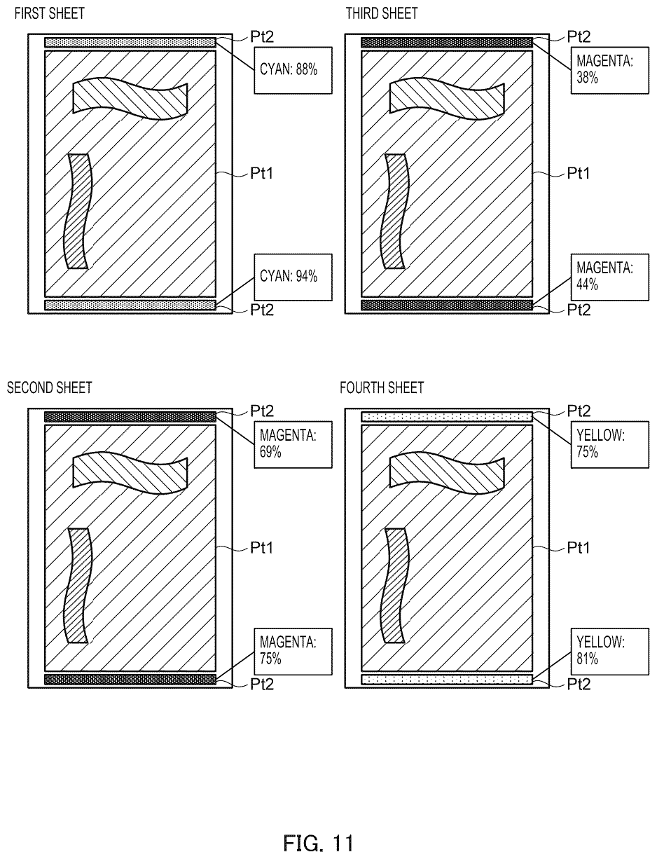

FIG. 11 is a diagram illustrating a modification example of the configuration of the color measurement patches Pt2. FIG. 11 illustrates an aspect in which the color measurement patches Pt2 of the toner images of the respective colors having the densities determined as described above are separately formed at the upstream end portion and the downstream end portion of the recording medium P in the sub-scanning direction (i.e., the conveyance direction). In this case, the color measurement patches Pt2 of respective color toner images having the color densities determined as described above are formed over eight positions.

Note that the correction section 10d according to the present modification may use, as the correction value, the mean value of the deviation values between the reference values and the measurement values detected for the respective color measurement patches Pt2 formed with mutually different densities. For example, the correction section 10d calculates, for cyan, the mean of the divergence value between the measurement value and the reference value detected with the color measurement patch Pt2 having a density of 88% and the divergence value between the measurement value and the reference value detected with the color measurement patch Pt2 having a density of 94% as the correction value. At this time, since the correction section 10d accurately reflects the density deviation when the density of cyan is 90%, the mean value of the divergence value detected in the color measurement patch Pt2 having a density of 88% and the divergence value detected in the color measurement patch Pt2 having a density of 94% may be used as the correction value. For example, the correction section 10d may use, as correction values, weighted mean values based on an internal ratio of a distance between a density of 88% and a density of 90% and a distance between a density of 94% and a density of 90% when 90% is set as the reference position.

Although embodiments of the present invention have been described and illustrated in detail, the disclosed embodiments are made for purpose of illustration and example only and not limitation. The scope of the present invention should be interpreted by terms of the appended claims.

### Industrial Applicability

According to the image forming apparatus according to the present invention, it is possible to suppress the density unevenness in the printed image which occurs during the continuous printing.

What is claimed is:

1. An electrophotographic image forming apparatus capable of performing consecutive printing, the electrophotographic image forming apparatus comprising:
a hardware processor configured to:
analyze color information present in input image data set in a print job and determine, based on an analysis result, color density of each color toner image to be monitored,
form, based on the print job, a print image corresponding to the input image data in a first area of a recording medium, and form a color measurement patch of each color toner image in a second area of the recording medium at the determine color density,
measure, during the print job, color information on the color measurement patch formed on the recording medium that is sequentially printed, and
sequentially correct, during the print job, the input image data or image formation condition for performing printing at a next time point, the input image data or the image formation condition being corrected based on the measured color information on the color measurement patch such that density unevenness along a predetermined direction appearing in the print image is adjusted.

2. The image forming apparatus according to claim 1, wherein
the hardware processor forms the color measurement patch in the second area of the recording medium such that the color measurement patch extends from one end side to another end side of the recording medium along the predetermined direction.

3. The image forming apparatus according to claim 1, wherein
the hardware processor identifies a representative color of the input image data based on color frequency information present in the input image data, and determines the color density of each color toner image to be monitored based on the representative color.

4. The image forming apparatus according to claim 3,wherein
the hardware processor extracts the color frequency information present in the input image data for each predetermined width area of the input image data along the predetermined direction, and identifies the representative color of the input image data based on the color frequency information of each area.

5. The image forming apparatus according to claim 1, wherein
the predetermined direction is a main scanning direction.

6. The image forming apparatus according to claim 1, wherein
the predetermined direction is a sub-scanning direction.

7. The image forming apparatus according to claim 1, wherein
the first area is an image forming area in the recording medium, and
the second area is a cutting area in the recording medium.

8. The image forming apparatus according to claim 1, further comprising:
a receiver that receives, from a user, selection of a toner color to be monitored, wherein
the hardware processor is configured to selectively form, in the second area of the recording medium, the color measurement patch of the received toner color among all toner colors of the image forming apparatus.

9. A control method for an electrophotographic image forming apparatus capable of performing consecutive printing, the control method comprising:
analyzing color information present in input image data set in a print job and determine, based on an analysis result, color density of each color toner image to be monitored,
forming, based on the print job, a print image corresponding to the input image data in a first area of a recording medium, and forming a color measurement patch of each color toner image in a second area of the recording medium at the determine color density;
measuring, during the print job, color information on the color measurement patch formed on the recording medium that is sequentially printed, and
sequentially correcting, during the print job, the input image data or image formation condition for performing printing at a next time point, the input image data or the image formation condition being corrected based on the measured color information on the color measurement patch such that density unevenness along a predetermined direction appearing in the print image is adjusted.

10. A non-transitory computer-readable recording medium storing therein a control program for an electrophotographic image forming apparatus capable of performing continuous printing, wherein
the control program is configured to:
analyze color information present in input image data set in a print job and determine, based on an analysis result, color density of each color toner image to be monitored,
form, based on the print job, a print image corresponding to the input image data in a first area of a recording medium, and form a color measurement patch of each color toner image in a second area of the recording medium at the determine color density;
measure, during the print job, color information on the color measurement patch formed on the recording medium that is sequentially printed, and
sequentially correct, during the print job, the input image data or image formation condition for performing printing at a next time point, the input image data or the image formation condition being corrected based on the measured color information on the color measurement patch such that density unevenness along a predetermined direction appearing in the print image is adjusted.
